(19) United States
(12) Patent Application Publication
(10) Pub. No.: US 2024/0258014 A1
(43) Pub. Date: Aug. 1, 2024

(54) EMBEDDED MAGNETIC DEVICE INCLUDING MULTILAYER WINDINGS

(71) Applicant: Murata Manufacturing Co., Ltd., Nagaokakyo-shi, Kyoto-fu (JP)

(72) Inventors: Takayuki TANGE, Milton Keynes (GB); Scott Andrew PARISH, Milton Keynes (GB)

(21) Appl. No.: 18/565,410

(22) PCT Filed: Jun. 15, 2022
(86) PCT No.: PCT/US2022/033561

§ 371 Date: Nov. 29, 2023

Related U.S. Application Data
(60) Provisional application No. 63/210,803, filed on Jun. 15, 2021.

(51) Int. Cl. H01F 27/28; H01F 41/04

(52) U.S. Cl. CPC H01F 27/2804; H01F 27/2852; H01F 41/041; H01F 2027/2809; H01F 2027/2819

(57) ABSTRACT

A device includes a substrate; a magnetic core in the substrate, including a hole, and divided into a first half and a second half opposite to the first half; a first winding extending through the hole and around the magnetic core; a second winding extending through the hole and around the magnetic core; and a third winding extending through the hole, around the magnetic core, and around a portion of the first winding. The first and the third windings only extend around the same half of the magnetic core. At least one first turn of the second winding extends around the second half of the magnetic core.

### BACKGROUND OF THE INVENTION

### 1. Field of the Invention

The present invention relates to embedded magnetic devices, and particularly to embedded magnetic devices with multilayer windings.

### 2. Description of the Related Art

Power supply devices include magnetic components such as transformers and magnetic cores. The magnetic components typically contribute the most to the weight and size of the power supply device, making miniaturization and cost reduction difficult.

In addressing this problem, it is known to provide low-profile transformers and inductors in which a transformer or inductor is embedded in a cavity in a substrate made of resin, and the necessary input and output electrical connections for the transformer or inductor are formed on the substrate surface. The substrate can be a printed circuit board (PCB) that includes additional solder-resist layers and copper plating layers on the top and/or bottom surfaces of the substrate. The electronic components for the power supply device may then be surface mounted on the substrate. This allows a more compact and thinner power supply device to be made.

In one known method, a packaged structure having a magnetic component can be integrated into a printed circuit board. In such a known method, a cavity is formed in an insulating substrate made of epoxy-based glass fiber, a toroidal magnetic core is placed into the cavity, and the cavity is then filled with an epoxy gel so that the magnetic core is fully covered. The epoxy gel is then cured, forming a solid substrate having an embedded magnetic core. To provide vias and traces included in the primary and secondary windings, (1) through-holes are drilled in the solid substrate on the inside and outside circumferences of the toroidal magnetic core, (2) the through-holes are then plated with copper to form vias, and (3) traces are formed on the top and bottom surfaces of the solid substrate to connect respective vias together into a winding configuration and to form input and output terminals. In this way, coil conductors are created around the magnetic core. The coil conductors of an embedded transformer include coils forming the primary and secondary windings. Embedded inductors can be formed in the same way, but may vary in terms of the input and output connections, the spacing of the vias, and the type of magnetic core used.

A solder resist layer can then be added to the top and bottom surfaces of the substrate covering the surface traces, allowing additional electronic components to be mounted on the solder resist layer. In power supply devices, for example, one or more transistors and associated control electronics, such as integrated circuits (ICs) and passive components, may be mounted on the solder resist layer.

Power supply devices manufactured in this way have several associated problems. Air bubbles may form in the epoxy gel as it is solidifying. During reflow soldering of the electronic components on the surface of the substrate, these air bubbles can expand and cause failure of the power supply device.

Alternatively, a second known method can be used in which epoxy gel is not used to fill the cavity. In this method, through-holes are first drilled into a solid resin substrate at locations corresponding to the interior and exterior circumference of a toroidal magnetic core. The through-holes are then plated to form the vertical vias of the transformer windings, and metallic caps are formed on the top and the bottom of the vias. A toroidal cavity for the magnetic core is then routed in the solid resin substrate between the vias, and a ring-type magnetic core is placed in the cavity. The cavity is slightly larger than the magnetic core, and an air gap may therefore exist around the magnetic core.

Once the magnetic core has been inserted into the cavity, upper and lower epoxy dielectric layers are added to the substrate to cover the cavity and the magnetic core. Through-holes are drilled through the upper and lower epoxy layers to the caps of the vias, and plated, and traces are subsequently formed on the top and bottom surfaces of the substrate to form input and output terminals.

When the embedded magnetic components are transformers, a primary winding is provided on one side of the magnetic core, and a secondary winding is provided on the opposite side of the magnetic core from the primary winding. Transformers of this kind can be used in power supply devices, such as isolated DC-DC converters, in which isolation between the primary and secondary sides is required. The isolation distance is the minimum spacing between the primary and secondary windings.

In these known methods described above, the spacing between the primary and secondary windings must be large enough to achieve a high isolation value, because the isolation is only limited by the dielectric strength of air, in this case in the cavity or at the top and bottom surfaces of the device. The isolation value may also be adversely affected by contamination of the cavity or the surface with dirt.

For many products, safety agency approval is required to certify the isolation characteristics. If the required isolation distance through air is large, there will be a negative impact on product size. For mains reinforced voltages (i.e., 250 Vrms), a spacing of approximately 5 mm is required across a PCB from the primary windings to the secondary windings to meet the insulation requirements of EN/UL60950.

The size and spacing of the vias forming the primary and second windings of the transformer is therefore largely decided by the specifications for the power supply device. Vias have to have a sufficient diameter so that the vias can be successfully plated with metal and so that the traces can be formed in an appropriate winding pattern to connect the vias together. Furthermore, if vias are placed too closely together or too close to other components, such as the magnetic core, the capacitance and isolation characteristics of the power supply device can be adversely affected.

To meet the insulation requirements of EN/UL60950, an isolation distance of 0.4 mm is required through a solid insulator for mains referenced voltages (i.e., 250 Vrms), for example. FIG. 1 is a top view of an embedded magnetic component device with the upper winding layer exposed. The primary windings 410 of the transformer are shown on the left-hand side, and the secondary windings 420 of the transformer are shown on the right-hand side. In an isolated DC-DC converter, for example, the primary winding 410 and the secondary winding 420 of the transformer must be sufficiently isolated from one another. In FIG. 1, the central region of the substrate 305, the region circumscribed by the inner wall of the core cavity (shown by the concentric dotted circles) defines an isolation region 430 between the primary and the secondary windings. The minimum distance between the inner vias 412 and 422 of the primary and secondary windings 410 and 420 is the isolation distance and is illustrated in FIG. 1 by arrow 432.

FIG. 2 represents a side sectional view of the known device shown in FIG. 1. FIG. 2 shows a core 310, traces 413 forming the primary windings, traces 423 forming the secondary windings, outer vias 411 and 421, and inner vias 412 and 422. As shown, the distance 432 between the primary and secondary side can be reduced to about 0.4 mm, for example, allowing significantly smaller devices to be produced, as well as devices with a higher number of windings.

However, the device shown in FIGS. 1 and 2 has problems with coupling between the primary and secondary windings and with high leakage inductance. In operation, a large leakage inductance causes a voltage surge that can result in damage to connected circuitry, including the switching components. Additionally, leakage inductance causes a power transfer delay and poor load regulation when the circuit is operating at high frequency. The space inside the core is limited, and the device size would need to increase if more winding turns and corresponding through holes are needed, while maintaining the minimum isolation distance.

### SUMMARY OF THE INVENTION

To overcome the problems described above, preferred embodiments of the present invention provide compact embedded magnetic component devices each with windings wrapped around one side of a magnetic core and each with improved coupling and reduced leakage inductance.

According to a preferred embodiment of the present invention, an embedded magnetic component device includes an insulating substrate including a first side, a second side opposite the first side, and a cavity; a magnetic core included in the cavity and including an inner periphery and an outer periphery; a first electrical winding that extends through the insulating substrate and around the magnetic core; a second electrical winding that extends through the insulating substrate and around the magnetic core; a third electrical winding that extends through the insulating substrate and around the magnetic core; and a fourth electrical winding that extends through the insulating substrate and around the magnetic core. Each of the first, the second, the third, and the fourth electrical windings includes upper traces located on the first side of the insulating substrate; lower traces located on the second side of the insulating substrate; inner conductive connectors extending through the insulating substrate adjacent to the inner periphery of the magnetic core, the inner conductive connectors respectively defining electrical connections between respective upper traces and respective lower traces; and outer conductive connectors extending through the insulating substrate adjacent to the outer periphery of the magnetic core, the outer conductive connectors respectively define electrical connections between respective first upper traces and respective first lower traces. The first, the second, and the third electrical winding are closer to the magnetic core than the fourth electrical winding.

The upper and lower traces of the fourth electrical winding can be wider than the upper and lower traces of the first, the second, and the third electrical windings. The fourth electrical winding can include two outer conductive connectors between each respective first upper trace and respective first lower trace. The second electrical winding can overlap the first electrical winding. The upper traces of the first, the second, and the third electrical windings can be on a different layer of the insulating substrate than the upper traces of the fourth electrical winding, and the lower traces of the first, the second, and the third electrical windings can be on a different layer than the upper traces of the fourth electrical winding. The magnetic core can be octagonally shaped.

The embedded magnetic component device can further include a first isolation layer located on the first side of the insulating substrate between the first electrical winding and the second electrical winding, and a second isolation layer located on the second side of the insulating substrate between the first electrical winding and the second electrical winding. The first isolation layer and/or the second isolation layer can include a single layer.

According to a preferred embodiment of the present invention, an electrical circuit includes a circuit substrate, and the embedded magnetic component device of any one of the various other preferred embodiments of the present invention mounted to a first surface of the circuit substrate.

According to a preferred embodiment of the present invention, a method of manufacturing an embedded magnetic component device includes forming a cavity in an insulating substrate that includes a first side and a second side opposite the first side, installing a magnetic core in the cavity, the magnetic core including an inner periphery and an outer periphery, forming a first electrical winding that extends through the insulating substrate and around the magnetic core, forming a second electrical winding that extends through the insulating substrate and around the magnetic core; forming a third electrical winding that extends through the insulating substrate and around the magnetic core; and forming a fourth electrical winding that extends through the insulating substrate and around the magnetic core. Each of the first, the second, the third, and the fourth electrical windings includes upper traces located on the first side of the insulating substrate; lower traces located on the second side of the insulating substrate; inner conductive connectors extending through the insulating substrate adjacent to the inner periphery of the magnetic core, the inner conductive connectors respectively defining electrical connections between respective upper traces and respective lower traces; and outer conductive connectors extending through the insulating substrate adjacent to the outer periphery of the magnetic core, the outer conductive connectors respectively defining electrical connections between respective first upper traces and respective first lower conductive traces. The first, the second, and the third electrical windings are closer to the magnetic core than the fourth electrical winding.

The upper and lower traces of the fourth electrical winding can be wider than the upper and lower traces of the first, the second, and the third electrical windings. The fourth electrical winding can include two outer conductive connectors between each respective first upper trace and respective first lower trace. The second electrical winding can overlap the first electrical winding. The upper traces connected to the first electrical winding can be on a different layer than the upper traces connected to the second electrical winding, and the lower traces connected to the first electrical winding can be on a different layer than the lower traces connected to the second electrical winding. The magnetic core can be octagonally shaped.

The method can further include forming a first isolation layer located on the first side of the insulating substrate between the first electrical winding and the second electrical winding, and forming a second isolation layer located on the second side of the insulating substrate between the first electrical winding and the second electrical winding. The first isolation layer and/or the second isolation layer can include a single layer.

According to a preferred embodiment of the present invention, a method of providing an electrical circuit includes providing a circuit substrate and mounting the embedded magnetic component device of any one of the various other preferred embodiments of the present invention to the circuit substrate.

The method can further include mounting electronic components to a second surface of the circuit substrate that is opposite to the first surface.

According to a preferred embodiment of the present invention, a device includes a substrate; a magnetic core in the substrate, including a hole, and divided into a first half and a second half opposite to the first half; a first winding extending through the hole and around the magnetic core; a second winding extending through the hole and around the magnetic core; and a third winding extending through the hole, around the magnetic core, and around a portion of the first winding. The first and the third windings only extend around the first half of the magnetic core. At least one first turn of the second winding extends around the second half of the magnetic core.

Each of the first, the second, and the third windings can include top and bottom traces connected by inner and outer traces; the top traces of the first winding and the top traces of the third winding can be on different layers of the substrate; the bottom traces of the first winding and the bottom traces of the third winding can be on different layers of the substrate; the inner vias of the first, the second, and the third windings can be located within the hole; and the outer vias of the first, the second, and the third windings can be located on an exterior of the magnetic core. At least one second turn of the second winding can extend around the first half of the magnetic core. The inner vias of the first winding can be arranged in first and second rows, and the inner vias of the second winding can be arranged in a third row.

The magnetic core can have an octagonal shape, and the outer vias of the primary windings and the secondary windings can be arranged along three sides of the magnetic core. The device can further include a first insulation layer between the top traces of the first winding and the top traces of the second winding. The device can further include a second insulation layer covering the top traces of the second winding and a third insulation layer covering the bottom traces of the second winding.

According to a preferred embodiment of the present invention, a module includes a module substrate and the device of one of the various other preferred embodiments of the present invention mounted to the module substrate. The module can further include a synchronous rectifier, wherein the second winding can be connected to a gate of the synchronous rectifier. The module can be a resonant converter with a resonant frequency determined by an overlap of the first and the second windings.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 shows a top down view of an embedded magnetic component of the related art.

FIG. 2 represents a side sectional view of the device shown in FIG. 1.

FIG. 3 is a schematic of a DC-DC converter circuit that can include an embedded magnetic device.

FIGS. 4-8 are views of an embedded magnetic device with windings wrapped around one side of a magnetic core.

FIGS. 9-11 show a circuit module that includes an embedded transformer.

FIG. 12 is a schematic of a DC-DC converter circuit that can include an embedded magnetic device.

FIG. 13 shows a possible arrangement of four windings shown in FIG. 12.

FIGS. 14-19 shows different layers of a circuit module that can include the DC-DC converter circuit of FIG. 12.

### DETAILED DESCRIPTION OF PREFERRED EMBODIMENTS

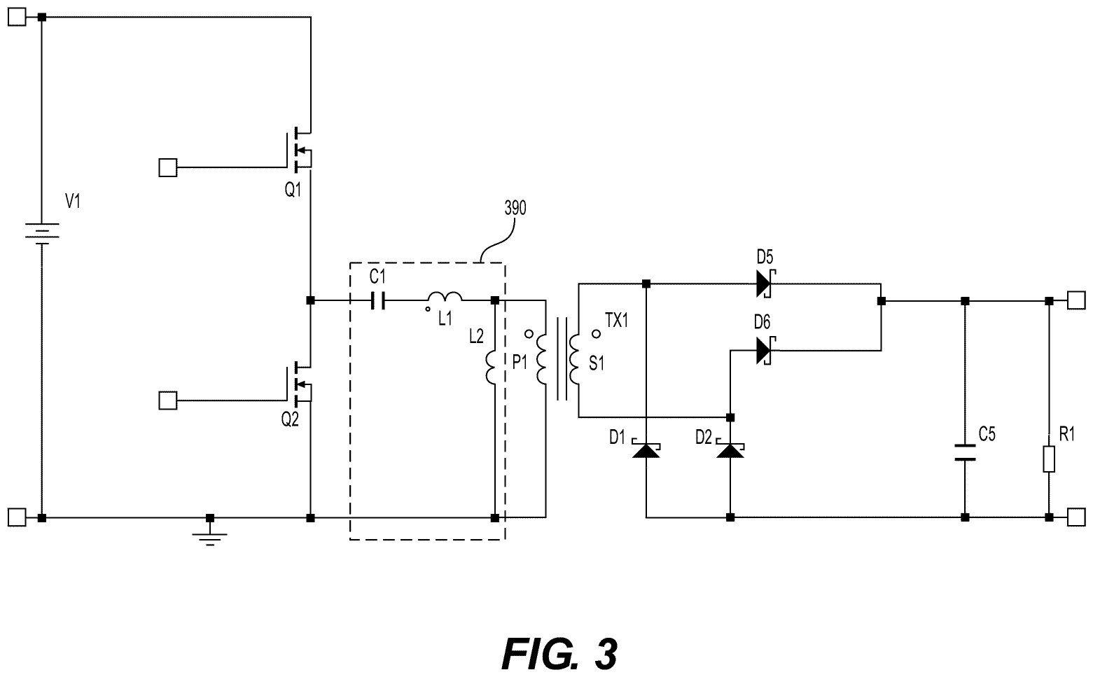

FIG. 3 shows a schematic of a DC-DC converter circuit that can include an embedded magnetic device. The DC-DC converter includes an input voltage V1; a switching stage including two transistors Q1 and Q2; a resonant tank 390 including a resonant capacitor C1, a resonant inductor L1, and a magnetizing inductor L2; a transformer TX1 including a primary winding P1 and a secondary winding S1; a rectification stage including diodes D1, D2, D5, and D6 in a bridge arrangement; an output capacitor C5; and a resistor R1 representing the load. The transistors Q1, Q2 are connected in series and are connected to the input voltage V1. The resonant tank 390 is connected between a node between the transistors Q1, Q2 and the transformer TX1. The resonant capacitor C1 and resonant inductor L1 can be connected in series but other arrangements are possible. The resonant inductor L1 can be the leakage inductance of the transformer TX1. The magnetizing inductor L2 is connected in parallel with the primary winding P1.

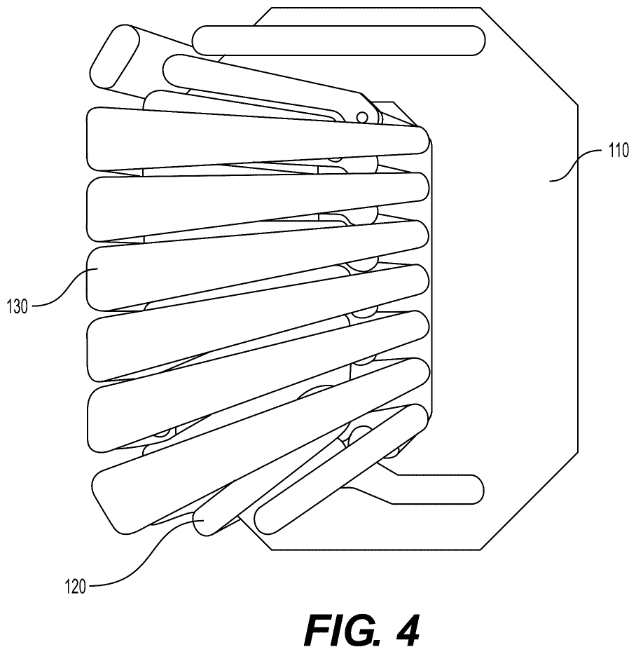

In the resonant topology shown in FIG. 3, the resonant inductance L1 can be adjusted to achieve the desired resonance frequency, which can be accomplished with a multi-layered embedded transformer TX1 shown FIGS. 4-8.

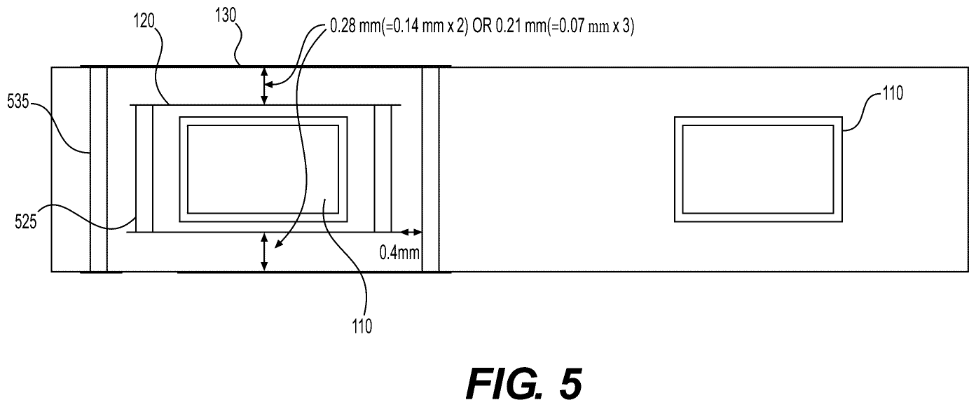

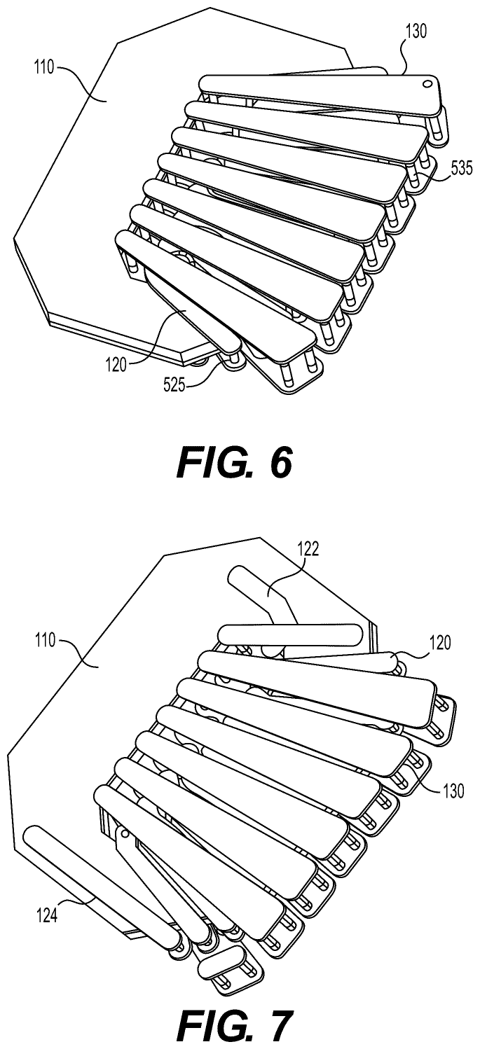

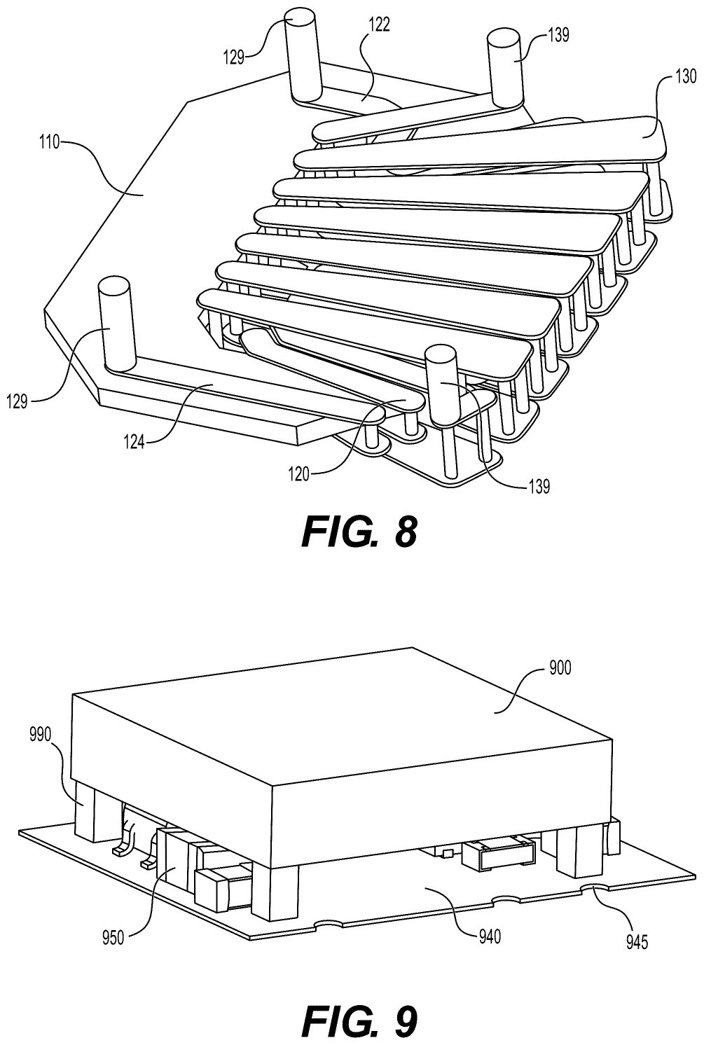

FIG. 4 is a bottom view, FIG. 5 is a side sectional view, FIG. 6 is a top perspective view, and FIGS. 7 and 8 are bottom perspective views of an embedded magnetic device with a primary winding 120 and a secondary winding 130 wrapped around one side of a magnetic core 110.

FIG. 4 shows an embedded transformer with multi-layer windings that includes a magnetic core 110, a primary winding 120, and a secondary winding 130 outside of the primary winding 120. The magnetic core 110 shown in FIG. 4 is octagonally shaped, but other shapes, including, for example, rectangular, can be used. Each of the primary winding 120 and secondary winding 130 is defined by traces connected by vias. Although the secondary winding 130 is shown to be outside of the primary winding 120, the inner winding could be the secondary winding 130, and the outer winding could be the primary winding 120.

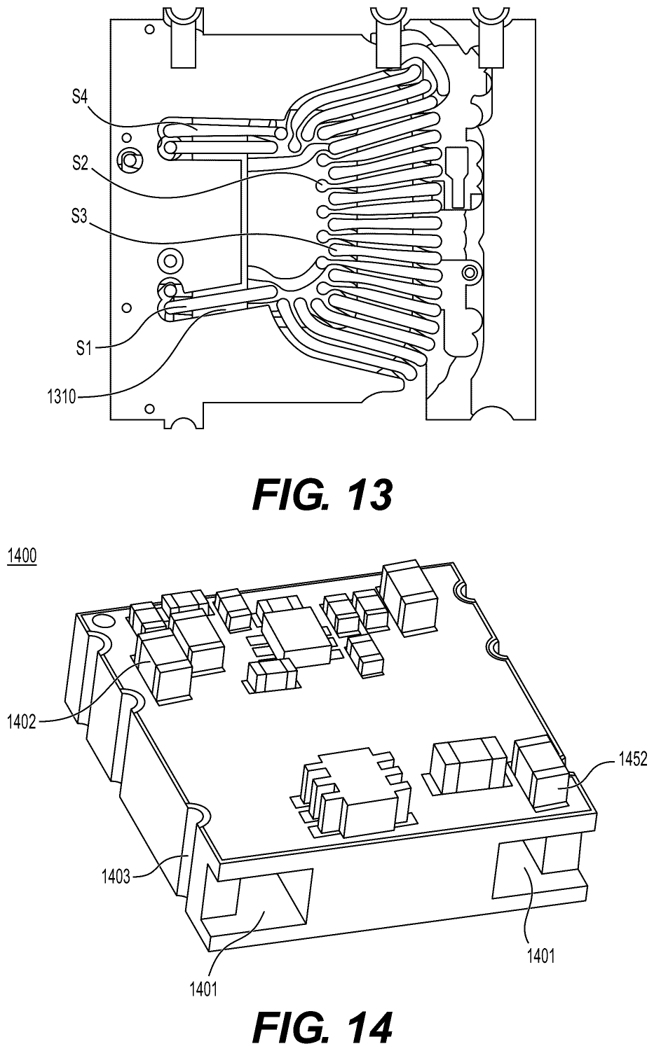

The primary winding 120 and the secondary winding 130 extend only around the same half of the magnetic core 110. No turns of either the primary winding 120 or the secondary winding 130 extend around the other half of the magnetic core 110. The primary winding 120 and the secondary winding 130 can have any number of turns. In FIG. 13, one or more auxiliary windings can be used that (a) extend around the same half of the magnetic core 110 as the primary winding 120 and the secondary winding 130 and/or (b) extend around the other half of the magnetic core 110. For example, an auxiliary winding can include turn(s) that extend around the same half of the magnetic core 110 as the primary winding 120 and the secondary winding 130 and can include turn(s) that extend around the other half of the magnetic core 110, which is similar to the arrangement shown in FIG. 13.

The primary windings 120 can include two rows of inner vias in a hole through the magnetic core 110 and one row of outer vias on the exterior of the magnetic core 110. The secondary winding 130 can include one row of inner vias in the hole through the magnetic core 110 and one row of outer vias on the exterior of the magnetic core 110.

As shown in FIG. 4, the inner vias of the primary winding 120 and the secondary winding 130 can be arranged in three rows. But other arrangements are also possible.

As shown in FIG. 4, the row of outer vias of the primary windings 120 can be adjacent to and can extend along a portion of the periphery of the magnetic core 110. The row of outer vias of the secondary winding 130 can be adjacent to the row of outer vias of the primary winding 120 and spaced farther away from the magnetic core 110 than the row of outer vias of the primary winding. The outer vias of the primary winding 120 and the secondary winding 130 can extend along a portion of the periphery of the magnetic core 110 that is less than half of the total periphery of the magnetic core 110. For example, if the magnetic core 110 has an octagonal shape as shown in FIG. 4, then the outer vias of the primary winding 120 and the secondary winding 130 can extend along one, two, or three sides of the magnetic core 110. If the magnetic core 110 has a rectangular shape, then the outer vias of the primary winding 120 and the secondary winding 130 can extend along one side of the magnetic core 110.

The hole of the magnetic core 110 defining an inner periphery of the magnetic core 110 can have any suitable shape. For example, in FIG. 4, the inner and outer peripheries can both have the same octagonal shape. But the inner and outer peripheries can have different shapes.

Although not shown, the magnetic core 110 can be housed within a cavity that can be formed in an insulating substrate. The substrate can include a resin material, such as FR4 or G10. FR4 and G10 are composite “pre-preg” materials composed of woven fiberglass cloth impregnated with an epoxy resin binder. The resin is pre-dried, but not hardened, so that when it is heated, it flows and acts as an adhesive for the fiberglass material. These materials have been found to have favorable thermal and insulation properties. The magnetic core 110 is then installed in a cavity in the substrate. The cavity may be slightly larger than the magnetic core 110, so that an air gap may exist around the magnetic core 110. Alternatively, the space between the magnetic core 110 and surfaces defining the cavity can be filled with a resin, a gel, or any other suitable material. The magnetic core 110 may be installed in the cavity manually or by a surface mounting device, such as a pick and place machine, for example.

A first insulating layer is secured or laminated on the top of the substrate to cover the cavity and the magnetic core 110. The first insulating layer can include a first metal layer used as traces of a portion of the primary winding 120 or the metal layer can be subsequently added. The bottom surface of the substrate can include a second metal layer used as traces of another portion of the primary winding 120 or the second metal layer can be subsequently added. Optionally, a second insulating layer and second metal layer can be secured to the bottom of the substrate.

Subsequently, a third insulating layer and a third metal layer are secured or laminated on the top of the first insulating layer and used as the traces of one a portion of the secondary winding 130. A fourth insulating layer and a fourth metal layer are secured or laminated on the bottom surface of the substrate or the second insulating layer and used as the traces of another portion of the secondary winding 130.

Additional insulating layers can be used. For example, one or more additional insulating layers can be included between the substrate and the first insulating layer, one or more additional insulating layers can be included between the first insulating layer and the third insulating layer, one or more additional insulating layers can be included between the substrate and the second insulating layer, and one or more additional insulating layers can be included between the fourth insulating layer and either the substrate or the second insulating layer.

The added insulating layers can be formed of the same material as the substrate as this facilitates bonding between the top and the bottom surfaces of the substrate and the intermediate insulating layers. The added insulating layers can therefore be laminated onto the substrate and each other. Lamination may be performed by, for example, applying an adhesive or by performing heat activating bonding between layers of pre-preg material. The substrate and additional insulating layers can be FR4, G10, or any other suitable material. Alternatively, the added insulating layers and the substrate can include different materials.

FIG. 5 represents a side sectional view of the transformer shown in FIG. 4. FIG. 5 shows that vias 525 and 535 can be formed through the substrate and additional insulating layers to connect the top and bottom winding layers to each other. FIG. 5 shows the magnetic core 110, the primary winding 120, the secondary winding 130, vias 525 connecting the inner layers of the primary winding 120, and vias 535 connecting the outer layers of the secondary winding 130.

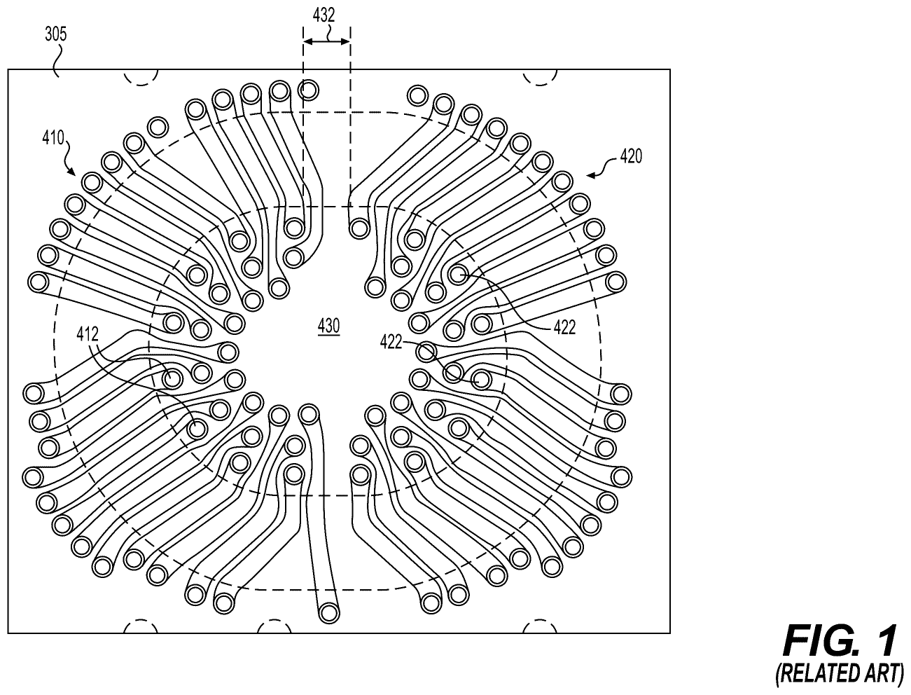

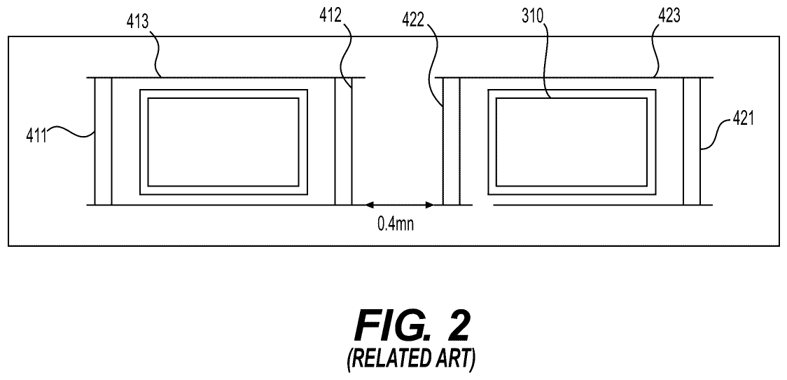

The magnetic core 110 can be a ferrite core as this can provide the device with the desired inductance. Other types of magnetic materials, and even air cores, that is an unfilled cavity formed between the windings of the transformer, are also possible. Although, in the examples above, the magnetic core 110 has an octagonal shape, it may have different shapes. The octagonal shape of the magnetic core 110 maximizes the magnetic space within the magnetic core for the induced magnetic field and the physical space for the vias 525 and 535. The magnetic core 110 can be coated with an insulating material to reduce the possibility of breakdown occurring between the conductive magnetic core 110 and the vias 525 and 535 or traces. This configuration of having the primary winding close to the secondary winding improves transformer performance characteristics of coupling, inductance, and resistance, while minimizing or decreasing the physical size of the transformer. For example, the coupling can be improved from about 0.916 from the configuration shown in FIG. 1 to about 0.991 in the configuration shown in FIGS. 4-8. Additionally, leakage inductance, and thus the resonant frequency of a resonant converter, such as the one shown in FIG. 3 that uses embedded transformer, can be controlled by overlapping portions of the primary and secondary windings 120 and 130.

Additional winding(s) can be included on the other portion of the magnetic core 110 that does not include any windings. However, in this case, the physical size of the transformer would increase and the size of the opening through the magnetic core 110 would also need to increase to accommodate the additional necessary through holes.

FIG. 5 also indicates exemplary dimensions of distances between the layers of the inner and outer winding layers of about 0.28 mm or about 0.21 mm and a distance between the metal layers of the primary winding 120 and the vias 535 of the secondary winding 130 at about 0.4 mm. To meet the insulation requirements of EN/UL60950, 0.4 mm separation is required through a solid insulator for mains referenced voltages (250 Vrms), for example.

If the added insulating layers and the substrate are FR4, then FIG. 5 shows the primary windings 120 and secondary windings 130 can be vertically separated (i.e., the distance between adjacent traces of the primary windings 120 and secondary windings 130) by two insulation layers with a thickness of about 0.14 mm within manufacturing and measurement tolerances (i.e., a total of about 0.28 mm within manufacturing and measurement tolerances) or can be vertically separated by three insulation layers with a thickness of about 0.07 mm within manufacturing and measurement tolerances (i.e., a total of about 0.21 mm within manufacturing and measurement tolerances). FIG. 5 also shows that the primary windings 120 and the secondary windings 130 can be horizontally separated (i.e., the shortest distance between traces or vias of the primary winding and the vias of the secondary winding) by about 0.4 mm within manufacturing and measurement tolerances.

The IEC and UL safety standards require the distances between the electric windings to be more than 0.4 mm when the windings are integrated in the same layer of a substrate. In other rules of the IEC and UL standards, a dielectric “thin film sheet” is applied to the isolation that should be secured in the vertical direction. When a material is used for the substrate with an isolation distance of 30 kV/mm, a minimum separation of 0.28 mm is required with two dielectric layers. With three dielectric layers, the minimum distance should be 0.21 mm. Accordingly, the isolation distances in the horizontal and vertical directions can be different from each other. The vias 525 and 535 are formed at suitable locations to form the primary and secondary windings 120 and 130 of the embedded transformer. Because the transformer includes a magnetic core 110 that is octagonal in shape with a corresponding octagonal-shaped opening in the center, the vias 525 and 535 are therefore suitably formed along portions of the opening and along one side of the outer circumference.

Through-holes can be formed by any combination of drilling, etching, or any other suitable process or technique. The through-holes can then be plated to form vias 525 and 535 that extend between the top and bottom traces of the corresponding primary and secondary windings 120 and 130.

Traces connecting the respective vias 525 and 535 define the windings of the transformer. The traces and the plating of the vias 525 and 535 are usually formed from copper, and may be formed in any suitable way, such as by adding a copper conductor layer to the outer surfaces of the insulating layer or substrate which is then etched to form the necessary patterns, depositing the copper onto the surface of the insulating layer or substrate, plating the copper onto the insulating layer or substrate, and so on. The width and shape of the traces forming the primary and secondary windings 120 and 130 can be configured to minimize resistance. For example, as shown, the width of the traces forming the secondary winding 130 are wider toward the outside of the trace farthest from the opening through the magnetic core 110. Additionally, as shown, there can be two vias 535 used to connect traces defining the secondary winding 130 to minimize resistance of the longer secondary winding 130. Additional vias can be used to connect the same traces, depending the width of the traces.

FIGS. 6 and 7 are respective top and bottom perspective views of the embedded transformer of FIG. 4 shown without the materials of the substrate or insulating layers. FIGS. 6 and 7 show the magnetic core 110, the layers of the primary winding 120, the layers of the secondary winding 130, the vias 525 of the primary winding 120, and the vias 535 of the secondary winding 130. The bottom perspective view of FIG. 7 shows that the primary winding 120 can include winding extensions 122 and 124 that can be used to locate and provide terminals to connect the primary winding 120 to outside circuitry, as shown in FIG. 8.

Like FIG. 7, FIG. 8 is a bottom perspective view of the transformer shown in FIG. 4 and includes terminal posts 129 and 139 used to connect the primary and secondary windings 120, 130 to a substrate or circuit. FIG. 8 shows the magnetic core 110, the secondary winding 130 including two terminal posts 139 at two ends of the winding, the primary winding 120, and the primary winding extensions 122 and 124 each connected to a terminal post 129. Although not shown, it is also possible to provide, for example, additional terminal posts to center tap a winding.

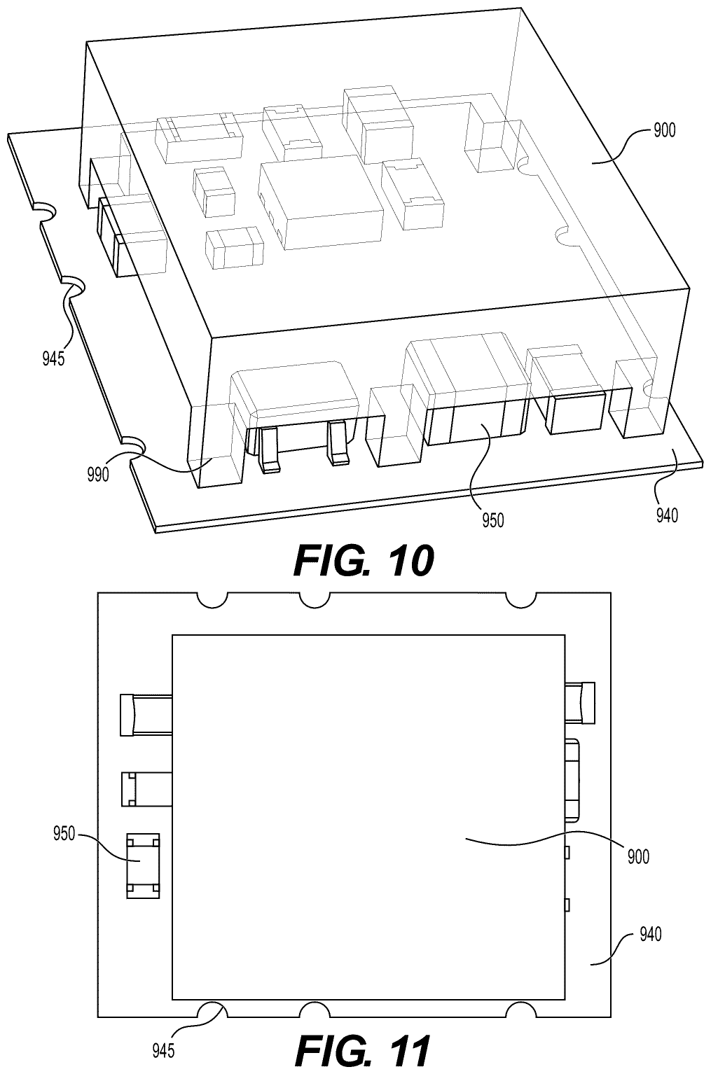

FIGS. 9-11 show a circuit module including an embedded transformer 900 with multi-layer windings. The circuit module can be a DC-DC converter, such as that shown in FIG. 3, a power supply, or any other suitable circuit. As shown, the circuit module can include the embedded transformer 900 mounted to a substrate 940 by terminal posts 990, and circuitry components 950 mounted to the substrate 940 under the transformer 900. The embedded transformer 900 can be structured like that previously described with respect to FIGS. 4-8. Like FIG. 9, FIG. 10 is a perspective view but with the transformer 900 and terminal posts 990 shown as transparent so that the electronic components underneath the transformer 900 are visible.

The substrate 940 can be a printed circuit board (PCB) that is single sided, double sided, or multi-layered. Circuitry components 950 can be mounted on the surface of the substrate 940 that is opposite to the surface to which the transformer 900 is mounted and/or can be mounted on a top surface of the transformer 900.

As shown in FIGS. 9-11 the substrate 940 can include castellations 945 on the edges of the substrate 940. The castellations 945 can be plated indentations or semicircular holes used to mount the substrate 940 to a host substrate. Alternatively, the castellations can be smaller or larger portions of a circle or can be plated holes. The castellations provide proper alignment between the substrate 940 and the host substrate on which the substrate 940 is mounted using soldering or another suitable method. Alternatively, the substrate 940 can include input/output pins, a connector, or any other suitable mechanism providing electrical connection between the circuit module and outside circuitry.

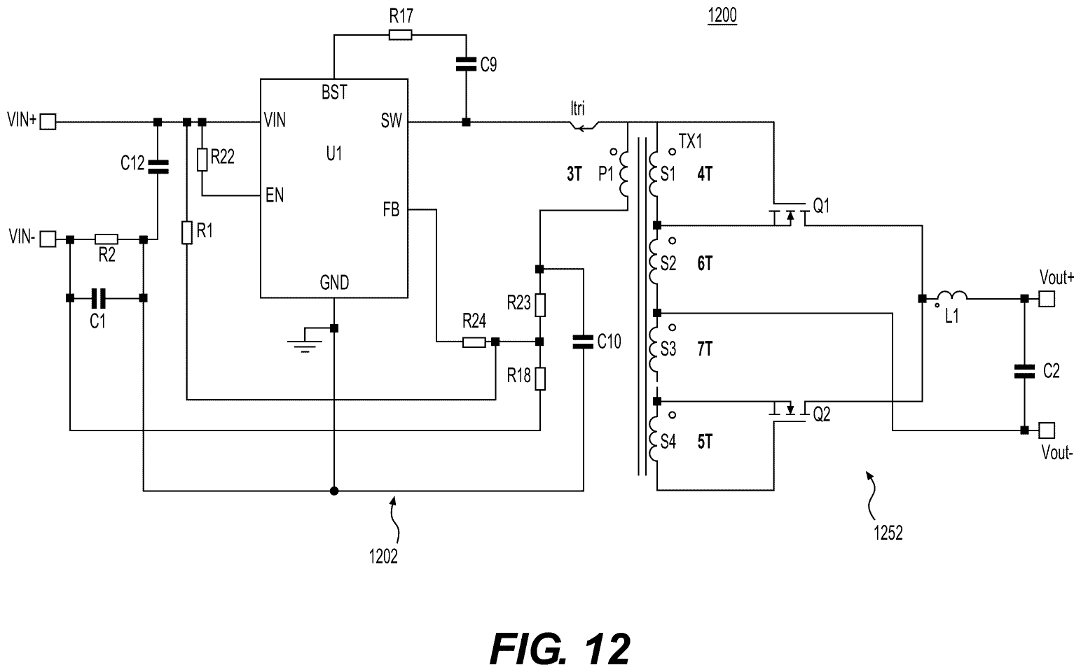

FIG. 12 shows a schematic of a DC-DC converter circuit that can include an embedded magnetic device. FIG. 12 shows an isolated DC-DC converter that improves the load regulation of the output voltage.

The isolated DC-DC converter 1200 of FIG. 12 includes a primary side 1202 and a secondary side 1252. The secondary side 1252 is coupled to the primary side via the transformer TX1. As shown in FIG. 12, the primary winding P1 can have 3 turns, the secondary winding S2 can have 6 turns, the secondary winding S3 can have 7 turns, the auxiliary winding S1 can have 4 turns, and the auxiliary winding S4 can have 5 turns. Each of these windings can have a different number of turns.

The secondary side 1252 includes secondary windings S2, S3, auxiliary windings S1, S4, a rectifying circuit, an output inductor L1, and an output capacitor C2. Power is transferred from the primary side to the output terminals Vout+, Vout− through the center-tapped secondary windings S2, S3. The center tap of the secondary windings S2, S3 can be connected to the output terminal Vout−. The rectifying circuit includes synchronous rectifiers Q1, Q2 that are connected between the transformer and the output inductor L1. The synchronous rectifiers Q1, Q2 can be self-driven synchronous rectifiers that each have a gate connected to one of auxiliary windings S1, S4 of the transformer TX1.

The primary side 1202 includes a step-down IC U1. Any suitable IC can be used as the IC U1. The IC U1 can include the following terminals: Vin+, SW, BST, EN, FB and GND terminals. In FIG. 12, the VIN+ terminal of the IC U1 can be connected to ground via a first capacitor C12. The SW terminal can be connected to one end of a primary winding P1. The BST terminal can also be connected to the one end of the primary winding P1, via a first resistor R17 and a second capacitor C9 in series. The other end of the primary winding P1 can be connected to ground via a third capacitor C10 and can be connected to an output terminal (not shown). The GND terminal can be connected to ground. If the IC U1 is enabled when a voltage applied to the EN terminal is high, then the EN terminal can be connected to the Vin+ terminal through a pull-up resistor R22 to limit the current into the EN terminal to prevent damage to internal components of the IC U1.

The other end of the primary winding P1 can be connected to a second resistor R23 and a third resistor R18 in series. The FB terminal is connected to the midpoint of the second resistor R23 and the third resistors R18 via a fourth resistor R24. The third resistor R18 can be connected to ground via the fifth resistor R2. A capacitor C1 can be connected in parallel with the fifth resistor R2 to filter noise and ripple voltage on the fifth resistor R2. The input voltage VIN is input between the VIN+ terminal and the midpoint between the third resistor R18 and fifth resistor R2. The arrangement of the fifth resistor R2 and the voltage input forms a duty-cycle compensation circuit, as will be described below. The FB terminal can also be connected to the VIN+ terminal through resistors R1 and R24, which can compensate line regulation by detecting the voltage level on the VIN+ terminal. The input voltage at the VIN+ terminal can have ±10% tolerance, and the operating duty cycle can be changed based on the detected voltage level of the input voltage, providing constant output voltage against a changing input voltage.

The purpose of the fifth resistor R2 is to improve the load regulation. When operating at higher frequencies, the output voltage of the secondary side can be reduced due to power transfer delay caused by the leakage inductance of the transformer TX1 and by the poor coupling factor between the primary winding P1 and secondary windings S2, S3 of the transformer TX1. This reduction of output voltage is greater with larger loads. The secondary side is always monitoring the primary side via the secondary windings S2, S3, and therefore the reduction in the output voltage due to the leakage inductance cannot be avoided. A circuit to compensate or directly monitor the secondary side could be used to improve the load regulation. However, this would result in a complex circuit, and care would be needed to ensure proper isolation of the secondary side. Instead, the isolated DC-DC converter 1200 offers a simpler solution by using the fifth resistor R2 of the duty-cycle compensation circuit.

The duty-cycle compensation circuit is configured to increase the duty cycle of a high-side switch (not shown) in the IC U1 to increase the output voltage to compensate for the power transfer delay. When the output current is connected to a load, a voltage drop is present on the fifth resistor R2. This voltage drop is sensed by the FB terminal of the IC U1, as the FB terminal is connected to an internal op-amp (not shown) of the IC U1 that maintains a fixed reference voltage at the FB terminal. When a heavy load is connected to the output, the current through the third resistor R18 becomes small, and the voltage on the third capacitor C10 increases. Therefore, the change in the voltage drop over the fifth resistor R2 causes a change in output voltage V_{OUT1}, which is also seen in the output of the secondary side 1252. In other words, the duty cycle of the IC U1 is increased by changing the load current. A heavy load increases the duty cycle, which compensates for the decrease in output voltage due to leakage inductance. Therefore, voltage regulation is improved by this on duty-cycle compensation circuit.

FIG. 13 shows a possible arrangement of the secondary windings S2, S3 and the auxiliary windings S1, S4 shown in FIG. 12. Similar to FIG. 12, in FIG. 13, the primary winding P1 can have 3 turns, the secondary winding S2 can have 6 turns, the secondary winding S3 can have 7 turns, the auxiliary winding S1 can have 4 turns, and the auxiliary winding S4 can have 5 turns. But, as with the windings in FIG. 12, each of these windings can have a different number of turns. FIG. 13 includes two auxiliary windings S1, S4, but any number of auxiliary windings can be used. For example, some applications can include only a single auxiliary winding. The secondary windings S2, S3 are only wound around one side of the magnetic core 1310. The auxiliary windings S1, S4 can be wound around both sides of the magnetic core 1310. The auxiliary winding S1 can include two turns that are each located between two adjacent turns of the secondary winding S3 and can include additional turns that either (a) extend around the same half of the magnetic core 1310 as the secondary windings S2, S3 but that are not between two adjacent turns of the secondary winding S3 or (b) extend around the other half of the magnetic core 1310. The auxiliary winding S4 can include a single turn that is located between two adjacent turns of the secondary winding S2 and can include additional turns that either (a) extend around the same half of the magnetic core 1310 as the secondary windings S2, S3 but that are not between two adjacent turns of the secondary winding S3 or (b) extend around the other half of the magnetic core 1310. Other possible arrangements of the auxiliary winding S4 are also possible.

FIG. 14 shows an example of a circuit module 1400 that can include the isolated DC-DC converter 1200 of FIG. 12. The circuit module 1400 can include one or more vents 1401. Although FIG. 14 shows two vents 1401 located in one side of the circuit module 1400, other arrangements and numbers of vent holes can be used. For example, the circuit module 1400 can include a single vent 1401 or can include two vents on opposite sides of the circuit module 1400. In FIG. 14, the circuit module 1400 includes a primary-side circuit 1402 and a secondary-side circuit 1452. The vents 1401 can be located on the same side of the circuit module 1400 as the secondary-side circuit 1452.

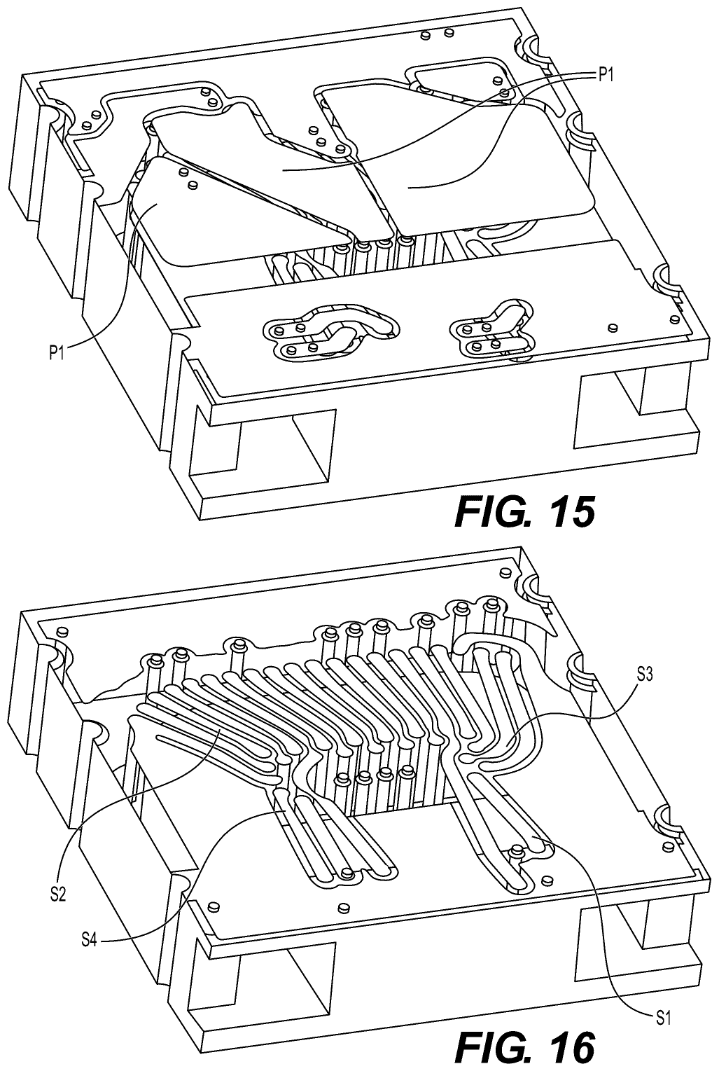

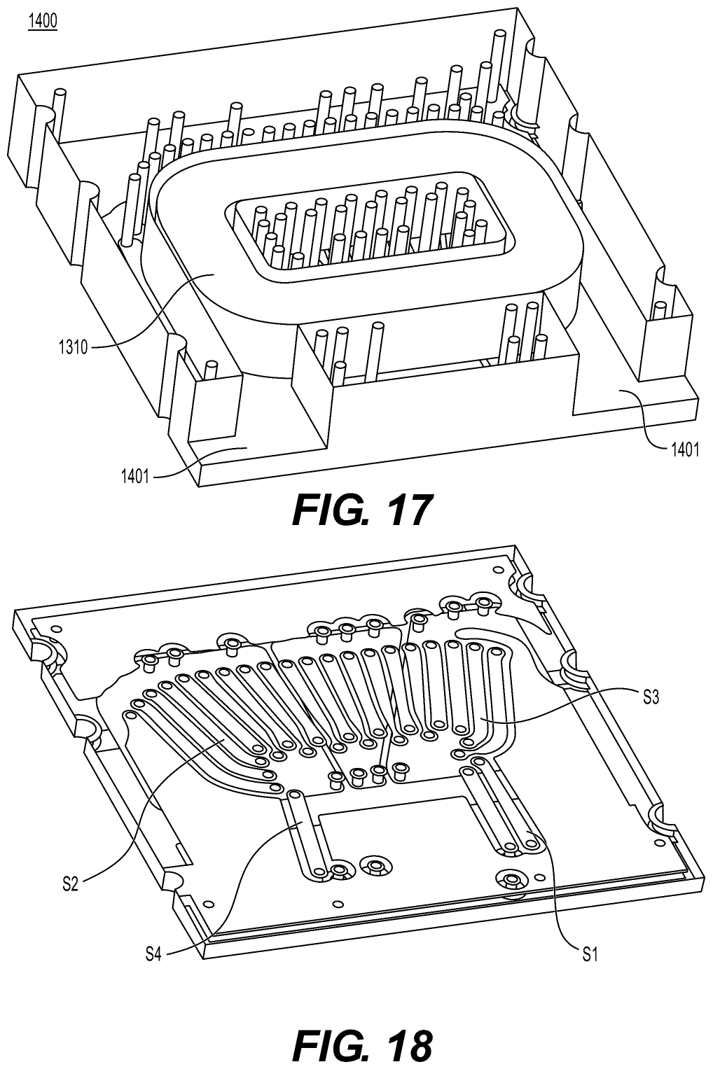

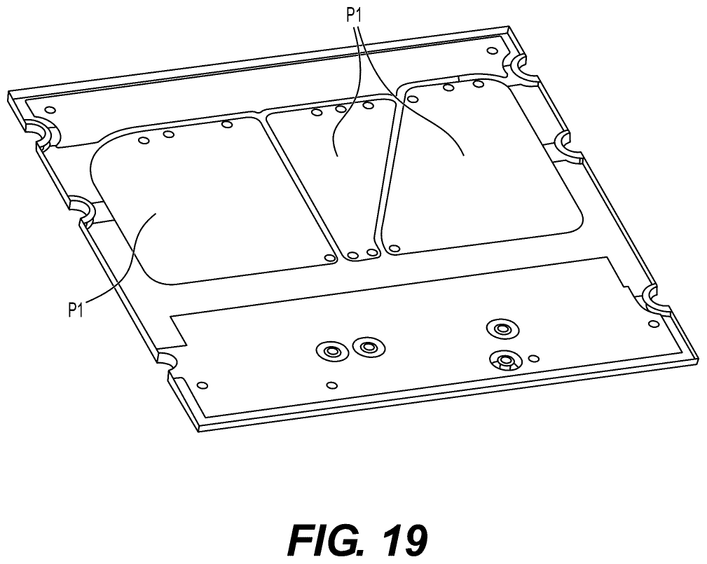

Each of the primary winding P1, the auxiliary windings S1, S4, and the secondary windings S2, S3 can include traces and vias that are connected together so as to extend around the magnetic core 1310. FIGS. 15-19 show various possible layers of the circuit module 1400. FIG. 15 shows a layer with top traces of the primary windings P1. FIG. 16 shows a layer with the top traces of the auxiliary winding S1, S4 and top traces of the secondary windings S2, S3. FIG. 17 shows the magnetic core 1310 in a cavity that is connected to the two vents 1401. FIG. 18 shows a layer with the bottom traces of the auxiliary winding S1, S4 and bottom traces of the secondary windings S2, S3. FIG. 19 shows a layer with bottom traces of the primary windings P1.

As shown in FIGS. 15-19, the traces in the primary winding P1 can be wider than the traces in the auxiliary windings S1, S4 and secondary windings S2, S3 and can be connected together by more than one via.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. An embedded magnetic component device comprising:
an insulating substrate including a first side, a second side opposite the first side, and a cavity;
a magnetic core included in the cavity and including an inner periphery and an outer periphery;
a first electrical winding that extends through the insulating substrate and around the magnetic core;
a second electrical winding that extends through the insulating substrate and around the magnetic core;
a third electrical winding that extends through the insulating substrate and around the magnetic core; and
a fourth electrical winding that extends through the insulating substrate and around the magnetic core, wherein
each of the first, the second, the third, and the fourth electrical windings includes:
upper traces located on the first side of the insulating substrate;
lower traces located on the second side of the insulating substrate;
inner conductive connectors extending through the insulating substrate adjacent to the inner periphery of the magnetic core, the inner conductive connectors respectively defining electrical connections between respective upper traces and respective lower traces; and
outer conductive connectors extending through the insulating substrate adjacent to the outer periphery of the magnetic core, the outer conductive connectors respectively define electrical connections between respective first upper traces and respective first lower traces, and
the first, the second, and the third electrical windings are closer to the magnetic core than the fourth electrical winding.

2. The embedded magnetic component device of claim 1,
wherein the upper and lower traces of the fourth electrical winding are wider than the upper and lower traces of the first, the second, and the third electrical windings.

3. The embedded magnetic component device of claim 1, wherein the fourth electrical winding includes two outer conductive connectors between each respective first upper trace and respective first lower trace.

4. The embedded magnetic component device of claim 1, wherein
the upper traces of the first, the second, and the third electrical windings are on a different layer of the insulating substrate than the upper traces of the fourth electrical winding, and
the lower traces of the first, the second, and the third electrical windings are on a different layer than the upper traces of the fourth electrical winding.

5. An electrical circuit comprising:
a circuit substrate; and
the embedded magnetic component device of claim 1 mounted to a first surface of the circuit substrate.

6. A method of manufacturing an embedded magnetic component device, the method comprising:
forming a cavity in an insulating substrate that includes a first side and a second side opposite the first side;
installing a magnetic core in the cavity, the magnetic core including an inner periphery and an outer periphery;
forming a first electrical winding that extends through the insulating substrate and around the magnetic core;
forming a second electrical winding that extends through the insulating substrate and around the magnetic core;
forming a third electrical winding that extends through the insulating substrate and around the magnetic core; and
forming a fourth electrical winding that extends through the insulating substrate and around the magnetic core; wherein
each of the first, the second, the third, and the fourth electrical windings includes:
upper traces located on the first side of the insulating substrate;
lower traces located on the second side of the insulating substrate;
inner conductive connectors extending through the insulating substrate adjacent to the inner periphery of the magnetic core, the inner conductive connectors respectively defining electrical connections between respective upper traces and respective lower traces; and
outer conductive connectors extending through the insulating substrate adjacent to the outer periphery of the magnetic core, the outer conductive connectors respectively defining electrical connections between respective first upper traces and respective first lower conductive traces; and
the first, the second, and the third electrical winding are closer to the magnetic core than the fourth electrical winding.

7. The method of claim 6, wherein the upper and lower traces of the fourth electrical winding are wider than the upper and lower traces of the first, the second, and the third electrical windings.

8. The method of claim 6, wherein the fourth electrical winding includes two outer conductive connectors between each respective first upper trace and respective first lower trace.

9. The method of any claim 6, wherein
the upper traces connected to the first, the second, and the third electrical winding are on a different layer than the upper traces connected to the fourth electrical winding, and
the lower traces connected to the first, the second, and the third electrical winding are on a different layer than the lower traces connected to the fourth electrical winding.

10. A method of providing an electrical circuit, the method comprising:
providing a circuit substrate; and
mounting the embedded magnetic component device of claim 6 to the circuit substrate.

11. A device comprising:
a substrate;
a magnetic core in the substrate, including a hole, and divided into a first half and a second half opposite to the first half;
a first winding extending through the hole and around the magnetic core;
a second winding extending through the hole and around the magnetic core; and
a third winding extending through the hole, around the magnetic core, and around a portion of the first winding; wherein
the first and the third windings only extend around the first half of the magnetic core; and
at least one first turn of the second winding extends around the second half of the magnetic core.

12. The device of claim 11, wherein
each of the first, the second, and the third windings includes top and bottom traces connected by inner and outer traces;
the top traces of the first winding and the top traces of the third winding are on different layers of the substrate;
the bottom traces of the first winding and the bottom traces of the third winding are on different layers of the substrate;
the inner vias of the first, the second, and the third windings are located within the hole; and
the outer vias of the first, the second, and the third windings are located on an exterior of the magnetic core.

13. The device of claim 11, wherein at least one second turn of the second winding extends around the first half of the magnetic core.

14. A module comprising:
a module substrate; and
the device of claim 11 mounted to the module substrate.

15. The module of claim 14, further comprising a synchronous rectifier; wherein
the second winding is connected to a gate of the synchronous rectifier.
